(19) United States
(12) Patent Application Publication
(10) Pub. No.: US 2002/0087566 A1
(43) Pub. Date: Jul. 4, 2002

(54) System and method for storage and processing of business information

(76) Inventors: Arthur G. McAleer III, Newfields, NH (US); William T. Neveitt, Allston, MA (US)

Correspondence Address: PENNIE AND EDMONDS, 1155 AVENUE OF THE AMERICAS, NEW YORK, NY, 100362711

(21) Appl. No.: 09/906,926

(22) Filed: Jul. 17, 2001

Related U.S. Application Data
(60) Provisional application No. 60/219,146, filed on Jul. 17, 2000.

(51) Int. Cl. G06F 7/00

(52) U.S. Cl. 707/100

(57) ABSTRACT

A preferred embodiment of the subject invention comprises a database architecture for identifying relationships between entities related to companies and methods for using that architecture to identify desired information about the companies and relationships between the companies and entities associated therewith. The architecture comprises a first set of data elements that represent companies; a second set of data elements that represent entities affiliated with one or more companies represented in the first set of data elements; and a third set of data elements that represent relationships between the first set of data elements and the second set of data elements. In a preferred embodiment, a directed, acyclic graph is used to represent the data elements.

### CROSS REFERENCE TO RELATED APPLICATIONS

This application claims the benefit of U.S. Provisional Application No. 60/219,146, filed Jul. 17, 2000.

### BACKGROUND

As the volume of information grows, access to timely, comprehensive business intelligence becomes a decisive competitive advantage. In particular, the ability to store the complex relationships between entities in a structured manner, and to use this information to support specialized processing suited to particular business activities, is much needed. Although some relational databases may capture individual pieces of information, there are significant benefits to a novel approach seeking to comprehensively represent the complex relationships among information pieces so that they may be used to improve business intelligence and processes.

### SUMMARY

A preferred embodiment of the subject invention comprises a database architecture for identifying relationships between entities related to companies, comprising a first set of data elements that represent companies; a second set of data elements that represent entities affiliated with one or more companies represented in the first set of data elements; and a third set of data elements that represent relationships between the first set of data elements and the second set of data elements, wherein the relationships between the first set of data elements and the second set of data elements represent relationships between the companies and the entities affiliated with the companies, and wherein data elements in the third set of data elements correspond to directed edges of a directed, acyclic graph comprising vertices corresponding to elements of the first and second sets of data elements.

A further preferred embodiment comprises a method of identifying companies with comparable product lines. This method preferably comprises the steps of (1) constructing a database comprising (a) a first plurality of data elements, each of which represents a company; (b) a second plurality of data elements, each of which represents a product produced by at least one company represented in said first plurality of data elements; (c) a third plurality of data elements, each of which represents an attribute of a product produced by at least one company represented in said first plurality of data elements; (d) a plurality of sub-elements, each of which represents information regarding a company or a product; (e) a first plurality of data entities, each of which represents a relationship between one of said first plurality of data elements and one of said second plurality of data elements; and (f) a second plurality of data entities, each of which represents a relationship between one of said second plurality of data elements and one of said third plurality of data elements; (2) defining a set S_{c} of potentially comparable companies, wherein said set comprises companies represented by said first set of data elements; (3) defining a set Sₚ of products produced either by said target company or by at least one company in said set S_{c} of potentially comparable companies; (4) defining a root count to be the number of companies that produce any of the products in Sₚ; (5) defining a target company C represented in said database to which other companies represented in said set S_{c} of potentially comparable companies are to be compared; and (6) identifying companies comparable to said target company by analyzing resemblances between products in Sₚ.

### BRIEF DESCRIPTION OF THE DRAWINGS

FIGS. 1 & 2 depict a preferred framework for characterizing company attributes.

FIG. 3 illustrates steps of a preferred method embodiment.

FIG. 4 depicts an example that illustrates the preferred method of FIG. 3.

### DETAILED DESCRIPTION OF PREFERRED EMBODIMENTS

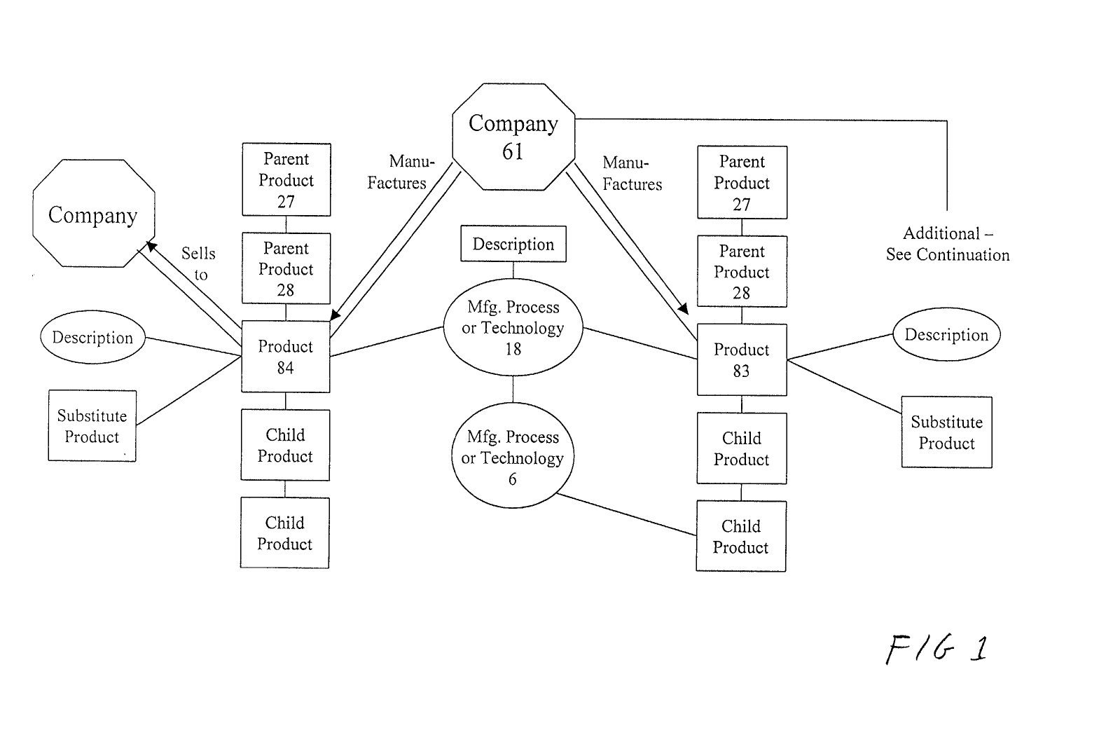

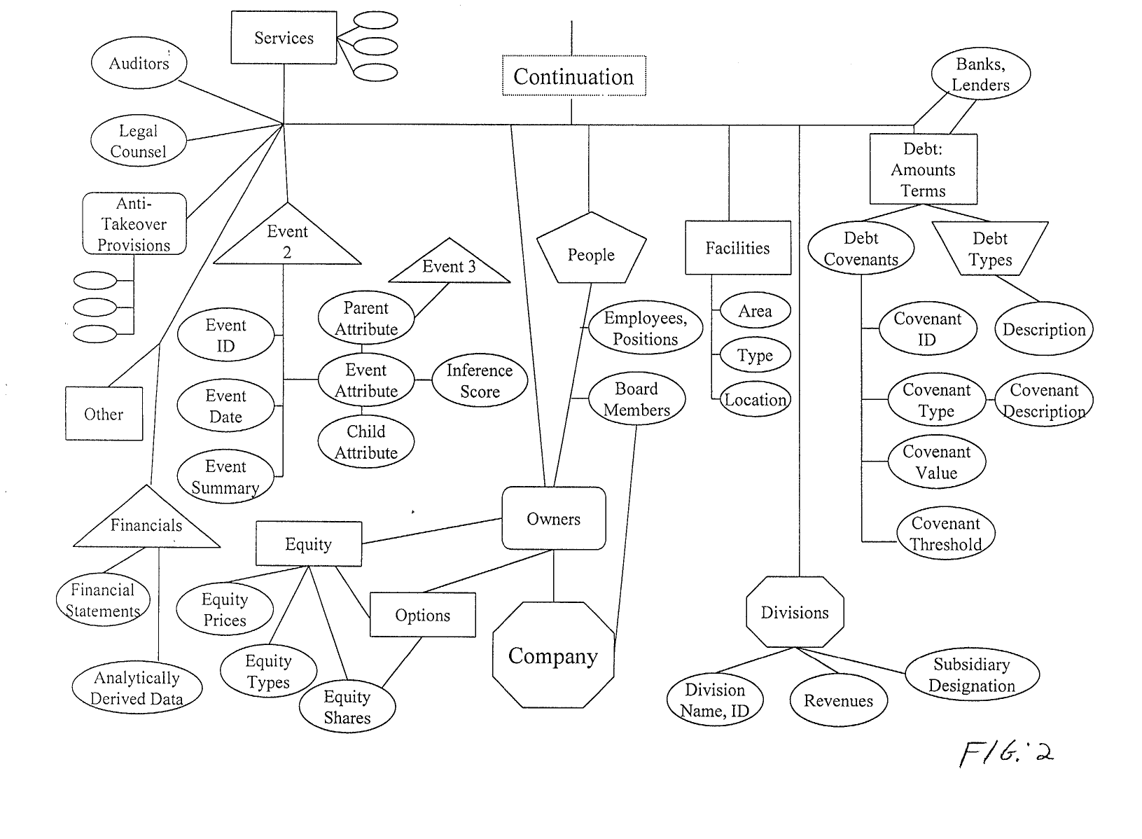

A preferred embodiment comprises an architecture that supports representation of many interrelated, highly granular data objects that pertain to any corporate entity, as well as descriptive attributes that characterize these objects and their relationships. FIGS. 1 & 2 illustrate this framework. In this description, the terms “framework,” “schema,” “database,” and “database system” are often used interchangeably.

Table 1 below lists a representative set of Elements and Sub-Elements within a preferred framework. Each Element in the framework may include a source reference to a document, another database, a table in another database, a row in another database table, or another Element or Sub-Element from which the given information may be verified. A source reference preferably contains a URL, a character offset within the given document, a range of characters representing the selected area, the date the relation was identified, and a numerical checksum that may be used to determine if the document has changed. For example, a relation representing the number of outstanding shares of common stock may contain a source reference pointing to the company's latest financial report, as well as the line in that document stating the number of outstanding shares.

In addition to the items that appear in Table 1, for each Element or Sub-Element there preferably also exists any and all information stored in that particular location of the schema which may consist of data, word-processed documents, text files, spreadsheets, reports, email and other communication, video files, audio files, transaction records and related data, collectively “Information.”

TABLE 1

| Element | Sub-Elements |
|---|---|
| Company | Name, name synonyms, description, address, email, phone, |
| | fax, date incorporated, parent company, URL, state |
| | incorporated, number of employees of a company, business |
| | unit, subsidiary |
| Products | Name, name synonyms, description, substitute products or |
| | services. Hereafter, the word ‘product’ is understood to apply |
| | to a good or service offered for sale by a Company. |
| Company | Systems, such as manufacturing processes or technologies, |
| Product | associated with the manner in which the company produces |
| Relation | the product. Also included is the type of relation |
| | (e.g. manufacturer, distributor). |
| Product | Name, description of manufacturing processes or |
| System | technologies, associated with the manner in which |
| | companies produce Products |
| Product | Descriptive product categories such as industry designations |
| Attributes | and/or parent products (for example, products within which |
| | a Product may serve as a subcomponent or material input) and |
| | child products (for example, subcomponents or material |
| | inputs that are used in or comprise a Product). Relations |
| | between attributes and products (and other attributes) are |
| | preferably represented by directed, acyclic graphs (DAGs). |
| Product to | Relation between a product/service and one or more product |
| Product | attributes that apply to it. |
| Attribute | |
| Relation | |
| Product | A directed acyclic graph of relationships between |
| System | descriptive Product System categories such as service, |
| Attribute | manufacturing, or technology designations. |
| Product | Relation between a Product System and one or more Product |
| System to | System attributes that apply to it. |
| Product | |
| System | |
| Attribute | |
| Product | Relations designating volume, quantity and price of a |
| Purchas- | particular Product one Company purchases or purchased from |
| ing | another Company in a specified time period. |
| Relation- | |
| ships | |
| Events | Name, date, description, reference to primary source article |
| | where applicable, reference to any Companies, People or other |
| | Elements or Sub-Elements involved in the event |
| Event | A directed acyclic graph of relationships between descriptive |
| Attributes | Event categories that apply to various business activities. For |
| | example, a board resignation, an acquisition, or a new product |
| | announcement. |
| Event to | Relations between an Event and one or more Event Attributes |
| Event | that apply to it. |
| Attribute | |
| Relations | |
| People | First name, last name, date of birth |
| Positions | Titles by which People are identified |
| People to | Relations between People, their professional Positions, and |
| Company | the Companies within which they hold such Positions. Also |
| Positions | includes the start date and end date of Position. |
| Board | People comprising the board of directors for a given Company |
| Board | For each member of a Board, the collection of Companies for |
| Affilia- | which that member holds a seat on the board of directors |
| tions | |
| People to | Relations between People and Companies comprising Board |
| Company | Affiliations |
| Board | |
| Relations | |
| Equity | Name, type of equity, description of equity securities |
| Types | |
| Option | Name, type of option, description of securities that are either |
| Types | options or contain embedded option features |
| Company | Relations between a Company and the Equity Types issued by |
| Equity | the Company. Includes quantity, ticker and exchange if the |
| | security is publicly traded. These relations may also contain |
| | values that have been derived analytically (e.g. Market Value |
| | of Equity and its formulaic components). |
| Company | Relations between a Company and the Option Types issued by |
| Options | the Company. Includes underlying option-able or converted |
| | Equity Type, quantity of options, quantity of exercisable |
| | options, exercise prices and average exercise prices. These |
| | relations may also contain values that have been derived |
| | analytically (e.g. Market Value of Equity). |
| Owners | Relations between People or Companies and the number of |
| | shares they own of a particular Equity Type in a given |
| | Company. |
| Company | Relations between a Company and one or more forms of Debt, |
| Debt | including Bank, amount borrowed, loan period, interest rate. |
| Debt | Name, description of a form of covenant pertaining to |
| Covenants | indebtedness |
| Debt | Name, description of a form of indebtedness |
| Company | Relations between one or more items of Debt issued by a |
| Debt | Company and one or more Debt Covenants, possibly |
| Covenants | including threshold values that define ‘pass’ or ‘fail’ states |
| | relative to the covenant(s). |
| Anti- | Name, description of anti-takeover provision |
| Takeover | |
| Provisions | |
| Company | Relations between Companies and one or more Anti-Takeover |
| Anti- | Provisions. |
| Takeover | |
| Facility | Name, description and location of real estate and facilities |
| Types | owned and, or operated by a Company |
| Company | Relations between Companies and the Facility Types they |
| Facilities | own or operate, including the geographical location and |
| | square area. |
| Company | Relations between Companies and their financial data, |
| Financials | including items from the balance sheet, income statement, and |
| | cash flows over specified time periods, as well as the Auditor. |
| | These relations may also contain values that have been |
| | derived analytically (e.g. Debt to EBITDA, Market Value of |
| | Equity). |
| Banks | Name, description of Company or People purchasing or |
| | lending Debt |
| Company | Relations between Companies and Banks in the context of |
| Banks | Debt and Debt Covenants |
| Auditors | Name, description of accounting firms |
| Company | Relations between Companies and their retained Auditors |
| Auditors | |
| Lawyers | Name, description of legal firms |
| Company | Relations between Companies and their retained Lawyers |
| Lawyers | |
| Admin | Sources, People that supply Information to the Schema, the |
| | Information supplied, the Element to which the Information |
| | pertains and the location (Schema table or row) into which the |
| | Information is deposited and stored. |

A directed acyclic graph (“DAG”) is a directed graph wherein no path starts and ends at the same vertex. A directed graph is graph whose edges are ordered pairs of vertices; a path is a list of vertices of a graph wherein each vertex has an edge from it to the next vertex. Thus, an example of a directed acyclic graph might be a mailman's path through a neighborhood—if the mailman does not start and end at the same location.

Note that in Table 1 we have defined parent (or ancestor) products as products within which a given product may serve as a sub-component or material input, and we have defined child (or descendant) products as sub-components or material inputs that are used in or comprise a given product. These relationships are depicted also in FIGS. 1 & 2: see Parent Products 27 and 28 of Product 84, which in turn has “child” and “grandchild” products. We shall generally use the term “ancestor attribute of a product” to refer to attributes that are either parents of a product or are parents of an attribute that is a parent of the product or has a descendent attribute that is a parent of the product. The term “descendent of an attribute” refers to an attribute or product that is a child of the attribute or is a child of a child, etc., of the attribute.

Analytical Processing Modules:

The Schema described above enables the performance of many powerful queries pertaining to or utilizing the competitive and commercial structure of an industry. A preferred embodiment comprises the following software modules:

Processing System for Evaluating Comparability of Companies:

Identifying comparable companies (i.e., companies with similar products in common) is a widely used technique for a variety of business purposes. Some illustrative purposes include, but are not limited to, establishing valuation baselines, assessing competitive threats, assessing impact of product pricing decisions, and identifying and optimizing potential customers and vendors.

We describe a preferred system for ranking companies in a database that are most closely comparable to a given company. The overall components of this system are illustrated in FIGS. 1 & 2, which is best understood in conjunction with the description in Table 1. There are several inputs required by the system: (1) a distinguished target company C for which comparable companies should be found; (2) a set S_{c} of potentially comparable companies; (3) a set Sₚ of products; (4) a directed, acyclic graph Gₐ of attributes representing features of the products; (5) a set of relations {Rₚ: p→{a}, pεSₚ, a εGₐ} designating attributes in the directed graph associated with each particular product; and (6) a set of relations {R_{cp}: c→{p}, cεS_{c}, pεSₚ} designating the products each company produces.

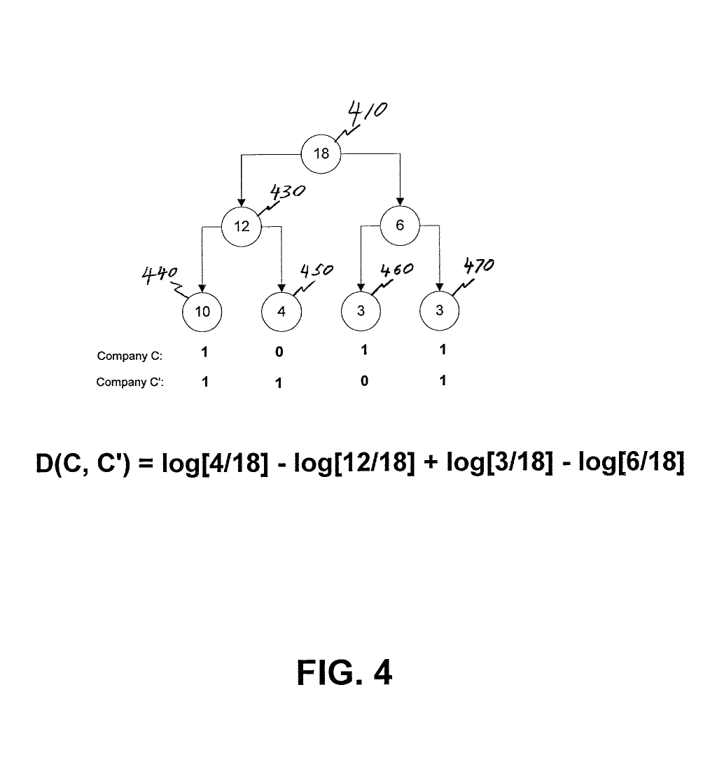

The system (and related method) is perhaps best illustrated with a simple example. Suppose a company C makes DAT data storage tapes as its only product. Call this product P. We wish to find companies C′ comparable to C. We construct a “product/attribute” DAG (see FIG. 4) with the following structure: nodes 440, 450, 460, and 470 correspond to products; in particular, node 440 corresponds to product P (DAT tapes). Node 450 corresponds to the product CD-ROMs. Node 460 corresponds to the product storage area network (SAN) software, and node 470 corresponds to the product database backup software. Typically, all “leaves” (nodes at the bottom) of a DAG will correspond to products, and the branches and root(s) (nodes at the top) will correspond to attributes.

Continuing with our example, node 430 represents an attribute (removable storage media) of the products DAT tapes (our product P) and CD-ROMs represented by nodes 440 and 450, respectively. Node 420 represents an attribute (data storage software) of the products SAN software and database backup software, represented by nodes 460 and 470, respectively. Finally, node 410, the “root node” for our DAG tree graph, represents parent attribute—computer industry—of the attributes removable storage media and data storage software, represented by nodes 430 and 420, respectively. We shall refer to this example, and to FIG. 4, as we explain the steps of a preferred embodiment below.

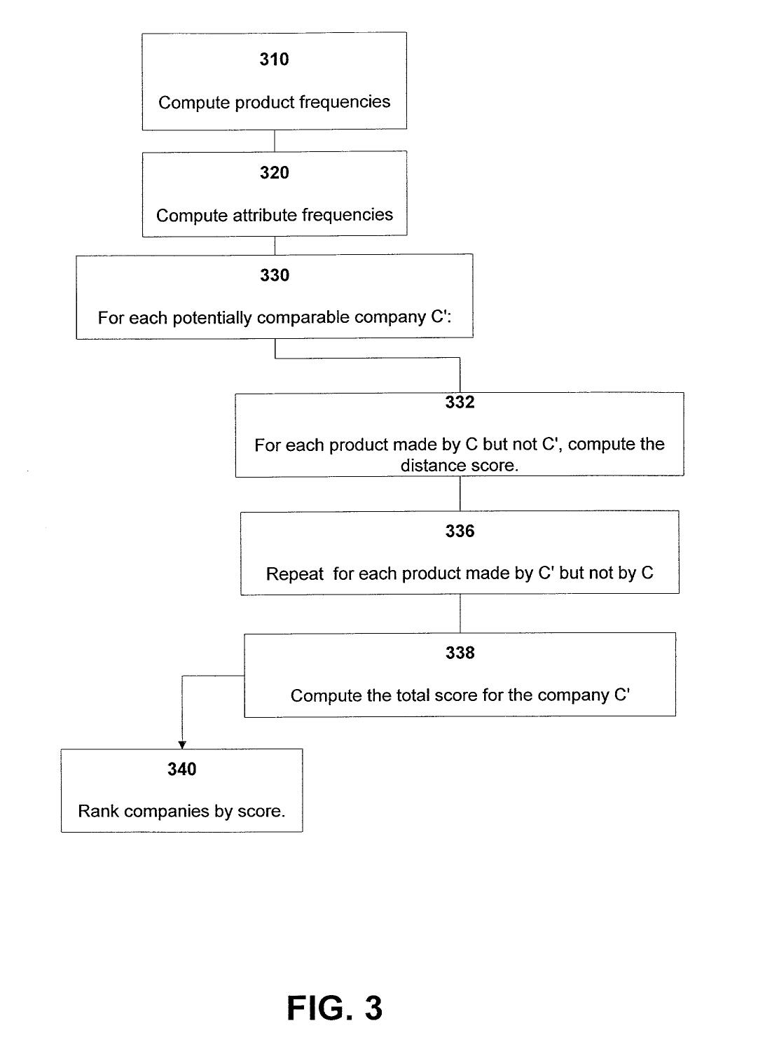

Each product in the set Sₚ is assumed to have at least one attribute node associated with it. Given these inputs, the system proceeds as follows (see FIG. 3):

Step 310: For each product in the set Sₚ compute a count equal to the number of companies in the set S_{c} that produce that product. Call this the p-count, or product frequency.

In our example, there are four products, corresponding to nodes 440, 450, 460, and 470. The number inside each of these nodes in FIG. 4 indicate the p-count of that product. Thus, the p-count of P is 10.

Step 320: For each attribute in Gₐ, compute a count (the “a-count” or “attribute frequency”) equal to the sum of the counts of all child nodes of that attribute, adjusted for duplications. Thus, if a product corresponding to a child node of a node that corresponds to an attribute of interest is made by a company B that also makes a product corresponding to a node that is another child node of the node corresponding to the attribute of interest, the a-count for the attribute of interest is reduced by 1 to account for the fact that company B would otherwise be counted twice. Ignoring the duplication problem, the a-count of an attribute A is simply the number of companies that produce products in the product set S_{A}, where S_{A}=set of products that are descendant products of A. Thus, the a-count of an attribute is the number of companies that produce at least one product that is a child product of that attribute.

In our example, Gₐ is the graph in FIG. 4; nodes for three attributes are displayed: 410, 420, and 430. Let us assume that two companies happen to produce both DAT tapes and CD-ROMs. Then, for the node 430 attribute, the a-count is 12:10 companies produce the node 440 product, and 4 companies produce the node 450 product. Absent duplication, the a-count would be 14, but since two companies were counted twice, the a-count is 12. If we assume that no two companies produce both of the node 460 and 470 products, we see that the a-count for the node 420 attribute is 6. If we also assume that there is no additional duplication, we see that the a-count for the root node 410 is 18.

More generally, we define a “root count” to be the number of companies that produce any of the products in the set Sₚ. In our example, and in all cases where the DAG is a tree, the root count is just the a-count for the root node attribute. But not all DAGs will be trees, so we need a root count definition that also works for those cases.

Step 330:

For each potentially comparable company C′εS_{c}, perform the following steps:

Step 332:

For each product πεSₚ produced by C but not by C′, compute a product score. The product score is computed as in steps 333 and 335 below (not depicted in FIG. 3):

Step 333:

Identify an attribute A in the product-attribute graph Gₐ that is an ancestor of π, is an ancestor of at least one product produced by company C′, and maximizes the quantity −log (a-count/root count).

In our example, there is only one product that is produced by C that is not produced by C′: the node 460 product. Thus, there are two candidate attributes: the node 420 attribute and the node 410 attribute. For the node 420 attribute, the quantity −log (a-count/root count)=−log (6/18)=log (3), while for the node 410 attribute the quantity −-log (a-count/root count)=log (18/18)=0. Thus the attribute that is identified in this step is the node 420 attribute.

Step 335:

Compute the product score as log(a-count/root count) −log(p-count/root count), where the a-count is for the attribute identified in step 333 and the p-count is for the product π. In our example, this product score is log (6/18)−log (3/18).

Step 336:

Repeat step 332 for each product made by company C′ but not by company C.

In our example, there is only one product that is produced by C′ that is not produced by C: the node 450 product. Thus, there are two candidate attributes: the node 430 attribute and the node 410 attribute. For the node 430 attribute, the quantity −log (a-count/root count)=−log (12/18)=log (3/2), while for the node 410 attribute the quantity −log (a-count/root count)=log (18/18)=0. Thus the attribute that is identified in this iteration of step 333 is the node 430 attribute. When we apply step 335, we get that the product score log(a-count/root count) −log(p-count/root count) is log (12/18)−log (4/18).

Step 338:

Compute a total score for company C′ by summing the scores of the products identified in steps 332 and 336. This total score is the distance D between the companies C and C′.

In our example, the result of step 338 is D(C, C′)=log (6/18)−log (3/18)+log (12/18)−log (4/18).

Step 340:

Rank all companies in the input set in order of increasing distance. The companies are thus ranked in this list from most comparable to least comparable.

Processing System for Collaboration:

Information of any file type pertaining to any Element or Sub-Element of the database system may be stored, retrieved and shared by any number of users. Furthermore, the database provides a structural foundation to support bi-directional communication among any number of users pertaining to any number of Elements in the database. Users may be Elements or Sub-Elements such as People, Admin, Companies, etc. The following examples are provided to illustrate the system at work, but are not the only such uses.

### EXAMPLE 1

Retention and sharing of documents or other information pertaining to any given Company C. The Companies table supports storing of N documents of any file type pertaining to Company C. Users accessing the database from user interfaces insert such documents or other information into the database, and retrieve such documents or other information from the database.

### EXAMPLE 2

Retention and sharing of transactions orders pertaining to equity or debt securities issued by any given company C. For instance, equity holders—typically large, institutional investors such as mutual fund managers—can coordinate their buying and selling activities with other investors through the database. Any given user identifies the Equity Type, Company, and quantity of securities pertaining to Company C such user wishes to transact (Transaction Order). N disparate users build and report multiple Transaction Orders through to the database. The database collects and holds the Transaction Orders centrally and enables these users to view the multiple Transaction Orders simultaneously.

Processing System to Support Collaboration, Commerce and, or Decision-Support:

The database serves as a substrate for supporting collaboration, commerce and decision-support through its representation of X-to-Y Relationships Through N Degrees of Separation, where X and Y are any two or more Elements or Sub-Elements in the database, and N represents some number of Elements or Sub-Elements that serve as linkages between X and Y. The following examples are provided to illustrate the system at work, but are not the only such uses.

### EXAMPLE A

People-to-People Relationships; tracing relationships among people based on common elements in the database. The common elements may include: (1) Board Affiliations: person A “knows” person B because they both appear as members of Company C's board of directors (one degree of separation), or because person A and person C both appear as members of Company C's board of directors and person C and person B both appear as members of Company D's board of directors (two degrees of separation), such that person A “knows” person B through N companies' boards of directors, constituting N degrees of separation; (2) Ownership of equity or debt securities: person A “knows” person B because they both appear as owners of Equity Types or Debt Types of Company C (one degree of separation), or because person A and person C both appear as owners of Equity Types or Debt Types of Company C and person B and person C both appear as owners of Equity Types or Debt Types of Company D (two degrees of separation), such that person A “knows” person B through N companies' securities owners, constituting N degrees of separation; and (3) Stored Documents or Communication: person A “knows” person B because they both contributed documents or communication or communicated to one another pertaining to Company C (one degree of separation), such that person A “knows” person B through N stored documents or communication, constituting N degrees of separation.

### EXAMPLE B

Company-to-Company Relationships; tracing relationships among companies based on common elements in the database. The common elements may include: (1) Board Affiliations: Company C “knows” Company D because they both have in common person A as a member of their board of directors (one degree of separation); (2) Products or Services: Company C “knows” Company D because Company C sells product A to Company D (one degree of separation), or because Company C sells product A to Company E and Company E in turn sells product A to Company D (two degrees of separation); and (3) Ownership of Equity Types: Company C “knows” Company D because Company C owns equity securities issued by Company D (one degree of separation), or because Company C owns equity securities issued by Company E and Company E in turn owns equity securities issued by Company D (two degrees of separation).

### EXAMPLE C

Product-to-Product Relationships; tracing relationships among products based on common elements in the database. The common elements may include: (1) Companies: product A “knows” product B because they are both sold by Company C (one degree of separation), or because product A is sold by Company C to Company D, and Company D also sells product B (two degrees of separation); and (2) Manufacturing Processes: product A “knows” product B because they are both manufactured using Manufacturing Process P (one degree of separation).

Although the subject invention has been described with reference to preferred embodiments, numerous modifications and variations can be made that will still be within the scope of the invention. No limitation with respect to the specific embodiments disclosed herein other than indicated by the appended claims is intended or should be inferred.

What is claimed is:

1. A database stored on a computer-readable medium and used to store and process business information, wherein said database comprises:
a first plurality of data elements, each of which represents a company;
a second plurality of data elements, each of which represents a product produced by at least one company represented in said first plurality of data elements;
a third plurality of data elements, each of which represents an attribute of a product produced by at least one company represented in said first plurality of data elements;
a plurality of sub-elements, each of which represents information regarding a company or a product;
a first plurality of data entities, each of which represents a relationship between one of said first plurality of data elements and one of said second plurality of data elements; and
a second plurality of data entities, each of which represents a relationship between one of said second plurality of data elements and one of said third plurality of data elements.

2. A database as in claim 1, further comprising a data representation of a directed acyclic graph comprising products and attributes.

3. A method of identifying companies with comparable product lines, comprising the steps of:
constructing a database comprising:
a first plurality of data elements, each of which represents a company;
a second plurality of data elements, each of which represents a product produced by at least one company represented in said first plurality of data elements;
a third plurality of data elements, each of which represents an attribute of a product produced by at least one company represented in said first plurality of data elements;
a plurality of sub-elements, each of which represents information regarding a company or a product;
a first plurality of data entities, each of which represents a relationship between one of said first plurality of data elements and one of said second plurality of data elements; and
a second plurality of data entities, each of which represents a relationship between one of said second plurality of data elements and one of said third plurality of data elements;
defining a set S_{c} of potentially comparable companies, wherein said set comprises companies represented by said first set of data elements;
defining a set Sₚ of products produced either by said target company or by at least one company in said set S_{c} of potentially comparable companies;
defining a root count to be the number of companies that produce any of the products in Sₚ;
defining a target company C represented in said database to which other companies represented in said set S_{c} of potentially comparable companies are to be compared; and
identifying companies comparable to said target company by analyzing resemblances between products in Sₚ.

4. A method as in claim 3, wherein said step of identifying companies comparable to said target company by analyzing resemblances between product lines comprises the steps of:
computing product frequencies;
computing attribute frequencies;
for each potentially comparable company C′εS_{c}, performing the following steps:
(a) for each product produced by C but not produced by C′, computing a product score;
(b) for each product produced by C′ but not produced by C, computing a product score; and
computing a distance score for C′ by summing the product scores computed in steps (a) and (b); and
ranking companies in S_{c} according to distance score.

5. A method as in claim 4, wherein step (a) is performed for each product produced by C but not produced by C′ by applying the following steps:
(i) identifying an attribute that is an ancestor attribute of said product produced by C but not produced by C′, is an ancestor of at least one product produced by company C′, and maximizes a quantity −log (a-count/p-count), where p-count is the product frequency for said product produced by C but not produced by C′ and a-count is attribute frequency; and
(ii) computing a product score by calculating the quantity log (a-count/root count)−log (p-count/root count), where a-count is the a-count for the attribute identified in step (i) and p-count is the p-count for said product produced by C but not produced by C′.

6. A method as in claim 5, wherein step (b) is performed in a manner analogous to step (a).

7. A database architecture for identifying relationships between entities related to companies, comprising:
a first set of data elements that represent companies;
a second set of data elements that represent persons affiliated with one or more companies represented in said first set of data elements; and
a third set of data elements that represent relationships between said first set of data elements and said second set of data elements, wherein said relationships represent relationships between said companies and said persons affiliated with said companies, and wherein data elements in said third set of data elements correspond to directed edges of a directed, acyclic graph comprising vertices corresponding to elements of said first and second sets of data elements.

8. A database architecture for identifying relationships between entities related to companies, comprising:
a first set of data elements that represent companies;
a second set of data elements that represent entities affiliated with one or more companies represented in said first set of data elements; and
a third set of data elements that represent relationships between said first set of data elements and said second set of data elements, wherein said relationships represent relationships between said companies and said entities affiliated with said companies, and wherein data elements in said third set of data elements correspond to directed edges of a directed, acyclic graph comprising vertices corresponding to elements of said first and second sets of data elements.
